(19) United States
(12) Patent Application Publication
(10) Pub. No.: US 2021/0199081 A1
(43) Pub. Date: Jul. 1, 2021

(54) METHOD FOR CALCULATING ONE-DIMENSIONAL SPATIAL FLUCTUATION IN UNBRANCHED HIGH-PRESSURE FUEL PIPE OF COMMON RAIL SYSTEM

(71) Applicant: HARBIN ENGINEERING UNIVERSITY, HARBIN CITY (CN)

(72) Inventors: JIANHUI ZHAO, HARBIN CITY (CN); XIANGDONG LU, HARBIN CITY (CN)

(21) Appl. No.: 17/038,914

(22) Filed: Sep. 30, 2020

(30) Foreign Application Priority Data
Dec. 30, 2019 (CN) 201911388094.3

(51) Int. Cl. F02M 55/04; F02M 63/02; F02M 55/02

(52) U.S. Cl. CPC F02M 55/04; F02M 55/025; F02M 63/023

(57) ABSTRACT

An objective of the disclosure is to provide a method for calculating a one-dimensional (1D) spatial fluctuation in an unbranched high-pressure fuel pipe of a common rail system. The method includes the following steps: dividing a flow in the unbranched high-pressure fuel pipe according to a spatial length into sections for solving, to obtain forward and reverse pressure fluctuation forms; iteratively calculating forward and reverse pressure fluctuations propagating in a fuel pipe model to obtain fluctuations of various sections of the fuel pipe from an inlet to an outlet within one step, and calculating a flow velocity at a corresponding position in the pipe; and extracting a corresponding flow rate of the system, and substituting into an iterative calculation of the overall system to obtain an output pressure.

### CROSS REFERENCE TO RELATED APPLICATION

This application claims the priority of Chinese Patent Application No. CN201911388094.3, entitled “Method for Calculating One-Dimensional Spatial Fluctuation in Unbranched High-Pressure Fuel Pipe of Common Rail System” filed with the China National Intellectual Property Administration on Dec. 30, 2019, which is incorporated herein by reference in its entirety.

### TECHNICAL FIELD

The disclosure relates to a method for calculating a pressure fluctuation in a fuel pipe of a diesel engine.

### BACKGROUND

In recent years, the reliability of the diesel engine has become more and more important. The injection pressure of the common rail system is not less than 80-100 MPa. In order to meet higher requirements, the injection pressure is much higher. Therefore, the high-pressure fuel pipe in the common rail fuel injection system must bear a huge load. One end of the high-pressure fuel pipe is connected to the booster pump, and the other end thereof is connected to the fuel injector, which often makes the output of the system lagging. Especially, when the high-pressure fuel pipe is long, there is an alternating reciprocating pressure in the pipe, which causes the injection efficiency and quantity of the diesel fuel to fluctuate, affecting the ignition and combustion performance of the diesel engine. Therefore, an effective method is needed to calculate the pressure fluctuation in the high-pressure fuel pipe. At present, some simulation software is used to model the high-pressure fuel pipe. The modeling only considers the pressure change in the high-pressure fuel pipe as a volume when the pipe parameters are small, and ignores the detailed pressure fluctuations at various positions inside the high-pressure fuel pipe. As a result, the calculation results are inaccurate.

### SUMMARY

An objective of the disclosure is to provide a method for calculating a one-dimensional (1D) spatial fluctuation in an unbranched high-pressure fuel pipe of a common rail system.

The objective of the disclosure is achieved as follows:

A method for calculating a 1D spatial fluctuation in an unbranched high-pressure fuel pipe of a common rail system, including:

(1) establishing a system model, including setting initial parameters, such as a control step Nₜ of the system, a total time N_{T} (0<Nₜ≤N_{T}) of a calculation process, and structure parameters and pressures of the high-pressure fuel pipe;
(2) dividing a flow in the unbranched high-pressure fuel pipe according to a spatial length into sections for solving, to obtain forward and reverse pressure fluctuation forms, namely forward pressure fluctuation F_{L} and reverse pressure fluctuation R_{L}:

$${F}_{x} = {F}_{x = 0} ( {N}_{t} - \frac{Δ L}{α} ) {e}^{- \frac{K Δ L}{α}} , {R}_{x} = {R}_{x = L} [ {N}_{t} - \frac{( L - Δ L )}{α} ] {e}^{- \frac{K ( L - Δ L )}{a}} ,$$

where, α is a speed of sound;

calculating real-time forward and reverse pressure fluctuations of each section in one control step Nₜ according to the current data;

(3) saving the current forward and reverse pressure fluctuations F and R into two arrays, calculating forward and reverse pressure fluctuations Fnd and Rnd propagating to a next step, and performing an iterative calculation on a fuel pipe model in N_{T}/Nₜ steps, to obtain a series of status values.

The disclosure may further include:

1. In step (1), the initial parameters that need to be set include:

a control step Nₜ of the system, a total time N_{T} (0<Nₜ≤N_{T}) of a calculation process, a length L and diameter dₕₚ of the high-pressure fuel pipe, fuel pressures P₀ enter and Pₑₓᵢₜ at an inlet and an outlet of the high-pressure fuel pipe and an initial pressure P₀ in the pipe; initial forward and reverse pressure fluctuations in the pipe are set as follows:

$$F = [ \begin{matrix}0 \\ ⋮ \\ 0\end{matrix} ] ; R = [ \begin{matrix}0 \\ ⋮ \\ 0\end{matrix} ] .$$

2. In step (2), according to a spatial length, a flow in the unbranched high-pressure fuel pipe is divided into sections for solving, to obtain forms of forward and reverse fluctuations caused by hydraulic shocks; a current pressure wave propagation distance is set as 0, and pressure fluctuation parameters in one control step Nₜ are calculated as follows:

a forward pressure fluctuation in the length of L from a length of ΔL:

$$F = [ \begin{matrix}F ( 0 ) \\ F ( Δ L ) \\ F ( Δ L + Δ L ) \\ ⋮ \\ F ( L )\end{matrix} ] ;$$

a reverse pressure fluctuation from the current length of ΔL:

$$R = [ \begin{matrix}R ( L ) \\ R ( L - Δ L ) \\ ⋮ \\ R ( Δ L ) \\ R ( 0 )\end{matrix} ] ;$$

forward and reverse pressure fluctuations in N_{T}/Nₜ steps from Nₜ:

Fnd(L*+ΔL)=F(L*)·e^{-KN}′, and Rnd(L*+ΔL)=R(L*)·e^{-KN}′;

where, 0<L*<L−ΔL, K is a dissipation factor;

when L*=0, the forward and reverse pressure fluctuations at a boundary are expressed as follows:

Fnd(ΔL)=Pₑₙₜₑᵣ−P₀+Rnd(ΔL);

when L*=L−ΔL, the forward and reverse pressure fluctuations at the boundary are expressed as follows:

Rnd(L)=P₀−Pₑₓᵢₜ+Fnd(L);

a flow velocity at any spatial position in the high-pressure fuel pipe is:

v(L*)=└F(L*)+R(L*)┘/(αρ).

3. In step (3), the flow velocity v(L*) at any spatial position in the high-pressure fuel pipe is used to extract a corresponding flow rate, and the flow rate is substituted into an iterative calculation of the system, to output the system's pressure at any time.

The disclosure has the following advantages. The disclosure incorporates a model of the detailed pressure fluctuation in the high-pressure fuel pipe into an overall model of the common rail system, which can be used to calculate the detailed pressure and other related parameters of the common rail system. The entire calculation and analysis structure has a clear logic, and provides an effective method for designing and calculating the detailed pressure of the high-pressure fuel pipe in the common rail system. In addition, the calculation results of the method are accurate.

### BRIEF DESCRIPTION OF THE DRAWINGS

FIG. 1 is a flowchart of the disclosure.

FIG. 2 is a schematic diagram of division of a spatial length of a high-pressure fuel pipe.

FIG. 3 shows a comparison of simulation and experimental results of an injection pressure of a fuel system.

### DETAILED DESCRIPTION

The disclosure is described in detail below with reference to the accompanying drawings and examples.

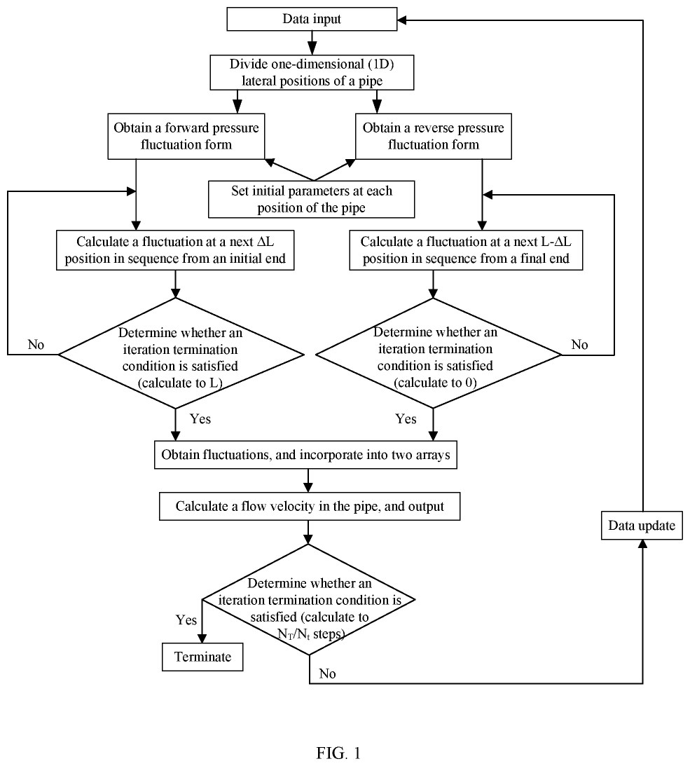

As shown in FIGS. 1 to 3, the disclosure provides a method for calculating a one-dimensional (1D) spatial fluctuation in an unbranched high-pressure fuel pipe of a common rail system. According to the overall flowchart as shown in FIG. 1, the method specifically includes the following steps:

Step 1: establish a system model, including setting initial status parameters, such as a control step Nₜ of the system, a total time N_{T} (0<Nₜ≤N_{T}) of a calculation process, and structure parameters and pressures of the high-pressure fuel pipe.

The initial parameters that need to be set include:

a control step Nₜ of the system, a total time N_{T} (0<Nₜ≤N_{T}) of a calculation process, a length L and diameter dₕₚ of the high-pressure fuel pipe, fuel pressures Pₑₙₜₑᵣ enter and Pₑₓᵢₜ at an inlet and an outlet of the high-pressure fuel pipe and an initial pressure P₀ in the pipe; initial forward and reverse pressure fluctuations in the pipe are set as follows:

$$\begin{matrix}F = [ \begin{matrix}0 \\ ⋮ \\ 0\end{matrix} ] & ( 1 ) \\ R = [ \begin{matrix}0 \\ ⋮ \\ 0\end{matrix} ] . & ( 2 )\end{matrix}$$

Step 2: divide a flow in the unbranched high-pressure fuel pipe according to a spatial length into sections (as shown in FIG. 2) for solving, to obtain forms of forward and reverse fluctuations caused by hydraulic shocks, namely forward pressure fluctuation F_{L} and reverse pressure fluctuation R_{L}:

$$\begin{matrix}{F}_{x} = {F}_{x = 0} ( {N}_{t} - \frac{Δ L}{α} ) {e}^{- \frac{K Δ L}{α}} & ( 3 ) \\ {R}_{x} = {R}_{x = L} [ {N}_{t} - \frac{( L - Δ L )}{α} ] {e}^{- \frac{K ( L - Δ L )}{α}} & ( 4 )\end{matrix}$$

where, α is a speed of sound; K is a dissipation factor, which is calculated by a resistance coefficient of the high-pressure fuel pipe:

first calculate the dissipation factor K, and then calculate real-time forward and reverse pressure fluctuations of each section in one control step Nₜ according to the current relevant data;

assume that the flow in the pipe is a turbulent flow, and calculate a Reynolds number based on a current average flow velocity in the pipe according to the following formula:

$$Re = \frac{\overline{V} {d}_{h p}}{ν} \qquad ( 5 )$$

where, V is the average flow velocity in the pipe, and v is a kinematic viscosity;

calculate the resistance coefficient λ of the fuel pipe according to a semi-empirical formula of the target fuel pipe, after obtaining the current Reynolds number;

dissipation factor:

$$K = λ \frac{\overline{V}}{2 {d}_{hp}} \qquad ( 6 )$$

assume that a current pressure wave propagation distance is 0, and calculate pressure fluctuation parameters in one control step Nₜ as follows:

a forward pressure fluctuation in the length of L from a length of ΔL:

$$F = [ \begin{matrix}F ( 0 ) \\ F ( Δ L ) \\ F ( Δ L + Δ L ) \\ ⋮ \\ F ( L )\end{matrix} ] \qquad ( 7 )$$

a reverse pressure fluctuation from the current length of ΔL:

$$R = [ \begin{matrix}R ( L ) \\ R ( L - Δ L ) \\ ⋮ \\ R ( Δ L ) \\ R ( 0 )\end{matrix} ] \qquad ( 8 )$$

forward and reverse pressure fluctuations in N_{T}/Nₜ steps from Nₜ:

Fnd(L*+ΔL)=F(L*)·e^{-KN}′ (9)

Rnd(L*+ΔL)=R(L*)·e^{-KN}′ (10)

where, 0<L*<L−ΔL, K is a dissipation factor;

when L*=0, the forward and reverse pressure fluctuations at a boundary are expressed as follows:

Fnd(ΔL)=Pₑₙₜₑᵣ−P₀+Rnd(ΔL) (11)

when L*=L−ΔL, the forward and reverse pressure fluctuations at the boundary are expressed as follows:

Rnd(L)=P₀−Pₑₓᵢₜ+Fnd(L) (12)

a flow velocity at any spatial position in the high-pressure fuel pipe is:

v(L*)=└F(L*)+R(L*)┘/(αρ) (13).

Step (3): save the current forward and reverse pressure fluctuations F and R into two arrays, calculate forward and reverse pressure fluctuations Fnd and Rnd propagating to a next step, use the flow velocity v(L*) at any spatial position in the high-pressure fuel pipe obtained in step (2) to extract a corresponding flow rate, and substitute the flow rate into an iterative calculation of the system, to output the system's pressure at any time.

Assuming j is a number of iterations, then the pressure output is:

P_{f}(j+1)=P_{f}(j)+ΔP_{f} (14)

where,

$$Δ {P}_{f} = \frac{E}{V} ( {Q}_{I N} - {Q}_{OUT} ) ,$$

Q_{IN}=S·v(L) is an outlet flow rate of the high-pressure fuel pipe.

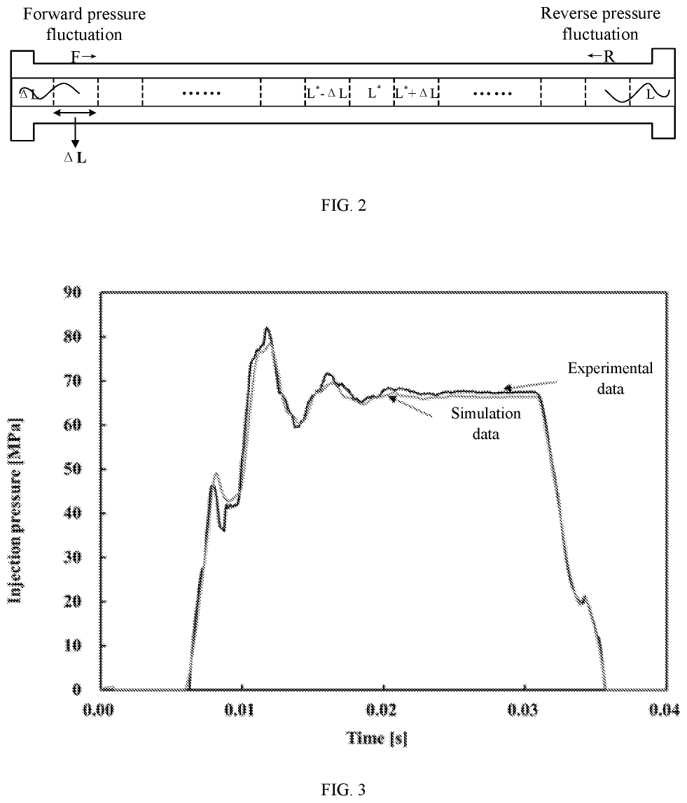

FIG. 3 shows a comparison of simulation and experimental results of the injection pressure of the fuel system, which indicates that the pressure fluctuations have good consistency.

What is claimed is:

1. A method for calculating a one-dimensional (1D) spatial fluctuation in an unbranched high-pressure fuel pipe of a common rail system, comprising the following steps:
(1) establishing a system model, comprising setting initial parameters, such as a control step Nₜ of the system, a total time N_{T} (0<Nₜ≤N_{T}) of a calculation process, and structure parameters and pressures of the high-pressure fuel pipe;
(2) dividing a flow in the unbranched high-pressure fuel pipe according to a spatial length into sections for solving, to obtain forward and reverse pressure fluctuation forms, namely forward pressure fluctuation F_{L} and reverse pressure fluctuation R_{L}:
$${F}_{x} = {F}_{x = 0} ( {N}_{t} - \frac{Δ L}{α} ) {e}^{- \frac{K Δ L}{α}} , {R}_{x} = {R}_{x = L} [ {N}_{t} - \frac{( L - Δ L )}{α} ] {e}^{- \frac{K ( L - Δ L )}{a}} ,$$
wherein, α is a speed of sound;
calculating real-time forward and reverse pressure fluctuations of each section in one control step Nₜ according to current data; and
(3) saving the current forward and reverse pressure fluctuations forms F and R into two arrays, calculating forward and reverse pressure fluctuations Fnd and Rnd propagating to a next step, and performing an iterative calculation on a fuel pipe model in N_{T}/Nₜ steps, to obtain a series of status values.

2. The method for calculating a 1D spatial fluctuation in an unbranched high-pressure fuel pipe of a common rail system according to claim 1, wherein in step (1), the initial parameters that need to be set comprise:
a control step Nₜ of the system, a total time N_{T} (0<Nₜ≤N_{T}) of a calculation process, a length L and diameter dₕₚ of the high-pressure fuel pipe, fuel pressures Pₑₙₜₑᵣ and Pₑₓᵢₜ at an inlet and an outlet of the high-pressure fuel pipe and an initial pressure P₀ in the pipe; initial forward and reverse pressure fluctuations in the pipe are set as follows:
$$F = [ \begin{matrix}0 \\ ⋮ \\ 0\end{matrix} ] ; R = [ \begin{matrix}0 \\ ⋮ \\ 0\end{matrix} ] .$$

3. The method for calculating a 1D spatial fluctuation in an unbranched high-pressure fuel pipe of a common rail system according to claim 1, wherein in step (2), according to a spatial length, a flow in the unbranched high-pressure fuel pipe is divided into sections for solving, to obtain forms of forward and reverse fluctuations caused by hydraulic shocks; a current pressure wave propagation distance is set as 0, and pressure fluctuation parameters in one control step Nₜ are calculated as follows:
a forward pressure fluctuation in the length of L from a length of ΔL:
$$F = [ \begin{matrix}F ( 0 ) \\ F ( Δ L ) \\ F ( Δ L + Δ L ) \\ ⋮ \\ F ( L )\end{matrix} ] ;$$
a reverse pressure fluctuation from the current length of ΔL:
$$R = [ \begin{matrix}R ( L ) \\ R ( L - Δ L ) \\ ⋮ \\ R ( Δ L ) \\ R ( 0 )\end{matrix} ] ;$$
forward and reverse pressure fluctuations in N_{T}/Nₜ steps from Nₜ:
Fnd(L*+ΔL)=F(L*)·e^{-KN}′, and Rnd(L*+ΔL)=R(L*)·e^{-KN}′;
where, 0<L*<L−ΔL, K is a dissipation factor;
when L*=0, the forward and reverse pressure fluctuations at a boundary are expressed as follows:
Fnd(ΔL)=Pₑₙₜₑᵣ−P₀+Rnd(ΔL);
when L*=L−ΔL, the forward and reverse pressure fluctuations at the boundary are expressed as follows:
Rnd(L)=P₀−Pₑₓᵢₜ+Fnd(L);

4. The method for calculating a 1D spatial fluctuation in an unbranched high-pressure fuel pipe of a common rail system according to claim 1, wherein in step (3), a flow velocity v(L*) at any spatial position in the high-pressure fuel pipe is used to extract a corresponding flow rate, and the flow rate is substituted into an iterative calculation of the system, to output the system's pressure at any time.
